(19) United States
(12) Patent Application Publication
(10) Pub. No.: US 2003/0233324 A1
(43) Pub. Date: Dec. 18, 2003

(54) Declining balance co-ownership financing arrangement

(76) Inventors: Mohamad L. Hammour, Paris (FR); Harvey E. Weiner, Bethesda, MD (US); James M. Milano, Arlington, VA (US)

Correspondence Address: NIXON & VANDERHYE, PC, 1100 N GLEBE ROAD, 8TH FLOOR, ARLINGTON, VA, 22201-4714, US

(21) Appl. No.: 10/406,010

(22) Filed: Apr. 3, 2003

Related U.S. Application Data
(60) Provisional application No. 60/369,341, filed on Apr. 3, 2002.

(51) Int. Cl. G06F 17/60

(52) U.S. Cl. 705/40; 705/38

(57) ABSTRACT

A Sharia compliant financing arrangement for home purchases and refinances that does not involve the payment of interest is disclosed. The financing arrangement is a declining balance Co-Ownership financing arrangement in which a limited liability affiliate of the party financing the purchase, called a co-owner, and the party borrowing the funds for the purchase, the consumer, co-own a residence through a tenancy-in-common. The consumer makes monthly payments to repay the amount funded through which the consumer increases his or her real property or Co-Ownership interest in the residence, while correspondingly decreasing the interest held by the co-owner. Gradually, by making the monthly payments, the consumer acquires the full ownership interest in the residence. The monthly payment has two parts, a profit payment and an acquisition payment. The acquisition portion of the payment is applied to the consumer's ownership interest, thereby increasing his ownership interest in the property and decreasing the co-owner's interest in the property. The co-owner's rights interest in the financing arrangement are transferable to a secondary market investor.

This application claims the benefit of Provisional Application No. 60/369,341, filed Apr. 3, 2002, the entire content of which is incorporated by reference in this application.

### FIELD OF THE INVENTION

The present invention relates to financial investments, and, in particular, to a method and system for financing home acquisitions that does not involve the payment of interest and allows the ownership interest purchased by the financier or its affiliate to be resold in the secondary market.

### BACKGROUND OF THE INVENTION

Most purchasers of homes require financing to assist them in paying for a home. Typically, such financing is in the form of a loan secured by a mortgage that requires the payment of interest as the mortgage loan is re-paid over time. Some prospective home purchasers, however, are unable to rely on traditional mortgages requiring interest payments because of religious constraints.

For example, under Islamic religious law, known as “Sharia”, the lending of money is viewed as a charitable, rather than a business or profit-seeking, endeavor. As a result, “Sharia,” prohibits paying and receiving interest on loans of money. Thus, Muslims who are not in a position to make an all-cash purchase of a residence because of a need to finance the purchase face a significant obstacle in their efforts to obtain home ownership. The obstacle is so significant that Muslims often rent their homes rather than purchase using a traditional mortgage financing arrangement. The religious constraints on financing the acquisition of a home through an interest-bearing loan have created a need to provide a financing arrangement that will meet Sharia, yet concurrently enable Islamic consumers who are not in a position to make an all-cash purchase of a home to still obtain the funds necessary to acquire a home.

The sources of Islamic law are numerous and its interpretations varied. One source of Islamic law is the Koran, although this is not the exclusive source. It is common for Sharia scholars to review financial transactions for the purpose of rendering their views and opinions. Sharia scholars sometimes differ in their interpretation of Islamic law, much like judges in the United States differ in their interpretation and views on the laws of the land (federal and state law). In many financial related transactions there is no consensus on what is acceptable and what is not acceptable under Islamic law.

Islamic law recognizes that co-owners of property may share the fruits of their Co-Ownership in a mutually agreeable manner. The arrangement between co-owners of property can be viewed as a business arrangement between the parties. Islamic law also recognizes that businesses are based on profit, and, thus, businesses need profit to survive.

A number of prior financing products or arrangements have been used, and are currently being used, in the marketplace to finance the purchase of residences by Muslims. However, these alternative arrangements have generally failed to meet the need of providing competitive financing to the Muslim community for home purchases due principally to the inability of the party financing the transaction to sell its interest to investors in the secondary market in an efficient manner because of product structuring constraints.

A “lease to own” arrangement is one of several interest-free arrangements previously used in the Islamic community to finance home purchases. Under Sharia, a property owner has the right to transfer the use of a home to someone else in exchange for rent. This lease (or “Ijara”) to own arrangement goes beyond a simple rental contract, in that there are two interdependent contracts: one to lease the property and the second to buy the property from the lessor or investor or financier, as the case may be. The consumer is obligated to acquire ownership of the home in which he or she is residing under a purchase contract and is obligated to pay rent under a lease contract. The consumer generally pays a monthly amount that goes towards the purchase price of the home, in addition to paying rent. Although there has been no known challenge by the IRS, arguably, under this arrangement, it is uncertain as to whether there is a tax deductible element to the consumer associated with the home being rented, since the consumer is arguably not a true owner of the property. Under this approach, the rental receipts could be taxed as rental income to the financier, while rental payments are not deductible as qualified residence interest. There are some fact specific instances where payments characterized as rent between the parties have been re-characterized as interest by the courts and the IRS, but none which are on point. While not completely settled, the “lease to own” arrangement is questionable as to the tax benefit of the deductibility of home mortgage interest and is not as beneficial to the lender/financier because of the tax uncertainty, as well as the difficulty in selling the financier's interest in the home in the secondary market. Since the financier holds title to the property, the financier may also be exposed to certain liabilities associated with ownership (e.g., suits, assessments and other legal actions) which are not easily insured. There are also landlord-tenant matters to be taken into consideration that can be perceived as adding additional liabilities and complexities.

An “installment sale contract” or “Murabaha” is a second type of interest-free funding arrangement that has been used by Muslims. An installment sale (forms of which include land contracts, a contract for deed or conditional sales contract), is very much like a traditional purchase money mortgage. Payments under the installment sale have amortization of debt or return of capital, as well as profit as components. In this arrangement, the seller/lender retains title and gives the homebuyer possession and most of the rights of ownership. In this transaction, the consumer selects the property and the financier purchases the property chosen by the consumer and then resells it to the consumer for the initial sales price plus an agreed upon profit. As stated, the title to the property generally is retained by the financier, which creates the inability for the financier to efficiently sell its interest in the transaction in the secondary market, and may also have the tax benefit issue discussed above. Since the financier holds title, the financier also may also be exposed to certain liabilities associated with ownership.

A third form of interest-free Islamic financing is the “decreasing partnership”. This is also a “rent-to-own” concept that can take various forms. There can be a partnership agreement, and ownership can be in the partnership itself. Alternatively, the lending institution can retain legal title in its name and the homebuyer has a savings investment in the institution that is transferred to the institution for the homebuyer to become a co-owning partner with the institution. The partnership leases the residence to the homebuyer at an agreed monthly rent. The homebuyer purchases more equity in the home from the partnership or partner over time. During the term of the rent, the homebuyer is paying the partnership the institution's portion of rent, but keeping his own, or applying it to purchase more equity. As the homebuyer increases his ownership by purchasing more partnership shares from the institution, his monthly rent to the partnership decreases in the same proportion. The limitation here again is the difficulty in the consumer obtaining a qualified residence interest, the limitations on the financier transferring ownership and the exposure of the liabilities to the financier which, when priced into the transaction, creates inefficiencies. This type of transaction can also be structured like a declining balance co-ownership where both the consumer and financier hold title to the property directly, although there is no legal partnership per se that is created.

A consumer seeking to build a home may also use an “Istisna” structure, in which case, the consumer will generally locate real property on which he or she seeks to build. The consumer would have the construction design plans prepared, select a builder and then contact the financier to fund the construction of the final product. The financier buys the property and hires the builder and provides the funding for the construction. When the property is completed, the financier will be entitled to payment from the consumer under the Murabaha, lease to own or partnership concepts. The consumer can act as the financier's agent during the construction process. The limitation here again is the difficulty in the consumer obtaining qualified residence interest, the limitations on the financier transferring its ownership interest in the secondary market, and the exposure of the financier to liabilities, which when priced into the transaction creates inefficiencies. It is also difficult and costly for a financier to commit to an arrangement of this nature, due to the need to coordinate the activities of many parties and ensure all obligations will be met.

Another arrangement that has been used by the Islamic community is “co-op financing” in which members of a community pool their funds to purchase housing. Cooperative financing is the financing of real estate with a particular type of concurrent ownership structure, usually a corporation. Other concurrent ownerships are partnerships, trusts, and individuals as joint tenants or tenants-in-common. The cooperative ownership is held by the corporation, the shares of which are divided among several persons who are entitled to lease a portion of space by virtue of that ownership interest. Ownership and the right to lease are inseparable. The tenant-stockholder may be entitled to deduct that part of the rent that represents the proportional share of real estate taxes and interest related to the property paid by the corporation, but this is not always the case. The primary limitation on the co-op arrangement is the finite amount of available funds, which are limited because these programs have little or no access to secondary markets. This results in delays and loss of opportunity to acquire desired housing. There is also the issue of exposure to liabilities at the entity level where all the properties are owned.

Other additional real estate financing arrangements that may be used by the Muslim community that involve equity participation or ownership, rather than interest based debt financing, include the “shared equity” and the shared income arrangements. Secondary market financing is unavailable for the shared income arrangement on single family homes. In shared equity arrangements, the co-owner lender participates in rent, profit and/or property appreciation. A variation that has been fairly common in real estate is the shared appreciation mortgage (“SAM”). Under this arrangement, for the down payment, a below-market sales price, or a monthly payment obligation, a non-occupant mortgagee shares in the appreciated home value at some date in the future (e.g., when the home is refinanced), or upon the sale of the property. Also, members of the Muslim community may incorporate an “equity kicker” concept in commercial ventures and this may include participation in the income and/or appreciation of the asset.

All of the foregoing transactions are too costly and complex to be broadly applied to the home financing market. All of these prior financing arrangements have presented one or more difficulties with respect to their use in financing home purchases by the Muslim community. Limitations include lack of tax deductibility, the assumption of liabilities by virtue of ownership undertaken by financiers, burdensome transfer taxes, and the lack of substantial funding sources. The differences inherent in these structures as compared to the conventional mortgage industry create additional costs that have resulted in lack of appeal from a consumer standpoint. This lack of volume and inability to transfer the asset in the hands of the financier has further resulted in unfavorable economics that discourage financiers and participants in the secondary marketplace. Islamic secondary market investors have not been able to purchase these products due to the fact the asset in the hands of the financier has usually been characterized by them as a receivable in a debt, as opposed to an ownership interest in property and profits to be generated therefrom.

### SUMMARY OF THE INVENTION

It is an object of the present invention to provide financing for home purchases to people who for reasons, such as religious ones, are incapable of participating or are unwilling to participate in the conventional residential mortgage market. It is another object of the present invention to provide a financing arrangement for the purchases of homes that avoids the use of interest payments. It is yet another object of the present invention to provide a financing arrangement for the purchases of homes that avoids the use of interest, but that is tax deductible and otherwise tax efficient and sellable in the secondary market. It is further an object of the present invention to limit the liability of the financier with respect to that portion of the property not held by the consumer, thereby making the financing more competitive with conventional financing and protecting the interest in the property held by the consumer. It is still a'further object of the present invention to provide a financing arrangement that enables a secondary market entity, such as Freddie Mac, to acquire the financing contract and hold it for its own account or to sell a security backed by a group of declining balance contracts to Sharia-sensitive investors.

The present invention is a declining balance Co-Ownership method and system of financing purchases of property, such as residential homes, automobiles, and other property, that avoids the use of interest payments. The declining balance Co-Ownership method of financing home ownership allows consumers to build up their equity in the property over time, just as in the case of traditional mortgage financing of a home. Unlike a traditional mortgage situation, however, in which the mortgagor typically has fee simple title to the residence, an affiliate of the party who provides access to financing the purchase, called a co-owner, and the party borrowing the funds for the purchase, called the consumer, co-own the residence. The consumer makes monthly payments to the co-owner through which the consumer increases his or her Co-Ownership interest in the residence, while correspondingly decreasing the interest held by the co-owner. The payments are made to the co-owner or its assignees in payment for the co-owner's interest in the residence until the consumer has acquired the full ownership interest in the residence. The present invention, as it applies to the relationship between the co-owner and consumer, uses a tenancy-in-common type of joint ownership relationship, as opposed to joint owners with rights of survivorship or tenants by the entireties. The consumer and co-owner are tenants-in-common, each with an undivided interest in the entire property to the extent of their ownership share and as agreed between the parties.

According to the method of the present invention, the consumer gradually acquires fill ownership of the property. The monthly payment made by the consumer to the co-owner is separated into two parts, i.e., a profit payment and an acquisition payment. The acquisition portion of the payment is applied to the consumer's ownership interest, thereby increasing his ownership interest in the property and decreasing the co-owner's interest in the property. Preferably, each month, or annually, the consumer receives a statement that reflects the increase in the consumer's ownership interest and the concurrent decrease in the co-owner's ownership interest. At the time the joint undertaking financing arrangement is created, the parties agree in writing on how the payments will be allocated.

Where a consumer uses an acquisition financing arrangement like an Ijara to purchase a property, the co-owner will have the full ownership interest in the property. In this situation, the deed to the property is in the name of the co-owner and the consumer's real property rights in the property are reflected only in agreements (lease and purchase agreement), similar to the Co-Ownership Agreement in that property rights are set forth under contract. Under the purchase agreement in an Ijara (lease to purchase), the consumer is obligated to acquire full ownership of the property by making monthly payments that again include an acquisition payment as part of the monthly payment. Here again, as the consumer makes the monthly payments, there is maintained a record of increases in the consumer's ownership portion of the property and decreases in the co-owner's ownership portion of the property in a deferred ownership account. The deed to the property is then transferred to the consumer upon full purchase of the property by the consumer, or upon a transfer event, such as a refinancing transaction where the consumer's name is placed on the deed of the property.

Preferably, to limit the liability of all parties, including the ultimate investor(s), the co-owner is a legal entity that has the attribute of limited liability. Preferably, a limited liability company (“LLC”) co-owns the interest in the property jointly with the consumer, although the co-owner can be a limited liability corporation, a limited liability partnership or a limited partnership.

Preferably, the LLC is registered in a low-cost jurisdiction, such as Delaware. Preferably, there is a separate LLC formed for one or more financings, whether it be for new purchases or refinancings. The LLCs may be owned by a wholly owned subsidiary of the financier or some third party, such as a charitable trust. By holding in a special purpose limited liability co-owner, such as an LLC or similar bankruptcy remote vehicle, the ownership interests that are most likely, if at all, to generate liability, the assets of the financier are insulated from exposure for liabilities created by the incidences of ownership. Each limited liability co-owner maintains the formalities of separateness and takes appropriate measures to avoid a piercing of the co-owner as a legal entity. The limited liability co-owner maintains a business/profit motive while minimizing its business contacts in the various states in which the respective properties are located. Preferably, the limited liability co-owner is treated as a pass-through entity or disregarded entity for federal tax purposes, thereby eliminating federal tax liability and preferably tax return filings all together, such as where a single member LLC is the limited liability co-owner. The name of the limited liability co-owner can be LLC-001, LLC-002, LLC-003, and so on as new legal entities are formed for multiple financing deals.

The monthly payment made by the consumer to the co-owner is based upon a price set by the secondary market investor, which can be Freddie Mac, for example. The monthly payment is competitive, and comparable to monthly payments paid by consumers with conventional mortgages. A formula that can be used to calculate the monthly payment is as follows:

acquisition amount=payment·(1−1/(1+r)^{ny})/r,

where

n=the number of periods per year,

y=the total number of years over which the acquisition payment will be made, and

r=the profit payment rate per period, given by the formula:

r=annual profit payment rate/n.

Adding the monthly acquisition payment amounts to the down payment originally made by the consumer provides the dollar amount of ownership of the consumer. Dividing the dollar amount of ownership of the consumer into the contract amount provides the percentage of ownership of the consumer in the residence.

Preferably, funds are placed in a non-interest bearing account. Funds placed in escrow (for items such as property taxes and insurance) may be required to be placed in an interest-type bearing account. To overcome the Sharia prohibition against interest, if the escrow funds are placed in an interest-type bearing account, the escrow amounts are separated from the interest generated from the funds. The interest generated by the funds is identified as being interest earned and is disbursed to the consumer as a separate payment. The consumer may decide to purify the interest received by contributing it to charity. Where applicable, because the interest owned on funds held in escrow is calculated, tracked, segregated, and separately remitted to the consumer, additional processing beyond the processing required for a conventional mortgage is performed.

According to the method of the present invention, at the initial stage of home acquisition, the financier and the co-owner are generally not involved; however, the financier may provide a consumer a pre-approval letter if requested by the consumer and an application for financing the purchase of a home. Preferably, the financier provides the consumer with a rider to the standard home purchase sales contract putting the seller of the home on notice that a co-owner will be involved in the transaction. Upon receiving a financing application, preferably the financier provides the consumer with traditional consumer protections provided in mortgage financings, such as Truth-in-Lending and Real Estate Settlement Procedures Act (“RESPA”) disclosures and state disclosures. Concurrently with the disclosures, the consumer and the financier enter into a commitment agreement, which describes the terms of the financing, including the required participation of the co-owner and the execution of the Co-Ownership Agreement by the consumer in exchange for the financier's commitment to provide funds for use in the purchase of a residence for the benefit of the consumer. Preferably, the commitment agreement includes an itemization of the estimated closing costs to be paid at closing.

At closing, the typical escrowing of funds, as well as the execution of contract documents, occurs. The consumer brings to the closing his initial acquisition payment, which is equivalent to a down payment. Preferably, all closing costs are the responsibility of the consumer and/or the seller of the property, with the co-owner bearing no responsibility for these costs under its agreement with the consumer.

Typically, a recorded deed reflects the tenants-in-common ownership of the consumer and the co-owner, and references the Co-Ownership Agreement, which includes an attached schedule that reflects the changing respective ownership percentages of the consumer and the co-owner to reflect the consumer's increasing equity and the co-owner's correspondingly decreasing equity as monthly payments are made. Preferably, no formal transfer of the changes in the respective ownership interests of the consumer and the co-owner occurs until a transfer event (e.g., sale or refinancing of the property) or the consumer acquires the last part of the co-owner's ownership interest in the financed property. At that time, the co-owner is obligated to deliver, preferably, a quit claim deed or other evidence of ownership to make the consumer the sole owner of the financed property. The ownership in the limited liability co-owner may be transferred to the consumer where this results in transfer tax savings or other efficiency under state law. While it is contemplated that the present invention will be used with real estate home purchases and refinancings or replacements of existing financing, it is possible to use the invention for financing other types of property.

In a “replacement” or refinancing transaction, there is no seller per se of the property and the agreements, such as the commitment agreement and the Co-Ownership Agreement, are modified accordingly. Where transfer taxes create inefficiencies in pricing and administration, preferably the deed remains in the name of the consumer and the Co-Ownership of the property is reflected only in agreements, such as the Co-Ownership Agreement.

At closing, the parties preferably execute four documents specific to the declining balance Co-Ownership financing arrangement of the present invention. These documents include: (1) the Co-Ownership Agreement, (2) a consumer's Obligation to Pay, (3) a Security Instrument, and (4) an Assignment Agreement and Amendment of Security Instrument. Additionally, the parties will typically execute certain other documents that would apply in a traditional mortgage situation. The last of the four documents list above is the Assignment Agreement and Amendment of Security Instrument that assigns the majority of the co-owner's rights in the property to the financier, including those of the co-owner under the Co-Ownership Agreement, the consumer's Obligation to pay and the Security Instrument. Notwithstanding this Assignment Agreement and Amendment to Security Instrument, the co-owner continues to retain legal title and the indemnity rights as to third party claims concerning liability arising from or related to: (i) consumer's use or occupancy of the property; or, (ii) occurrences on, related to or arising from the property. Under this Assignment and Amendment Agreement, the co-owner assigns and transfers to its assignee (i.e., the financier) all of its right, title and interests that it holds as beneficiary under the Security Instrument, and further irrevocably grants and conveys a power of sale in the co-owner's interest in the property. The Security Instrument, as well as the Assignment Agreement and Amendment of Security Instrument, will be recorded, along with the deed where applicable, which will reference the Co-Ownership Agreement. There is also a Definition of Key Terms document used that sets forth definitions of the defined terms used throughout the documents, including the commitment agreement.

The Co-Ownership Agreement sets forth the respective rights of the consumer and the co-owner in the financed residence. According to the invention, the consumer has the sole right to occupy the financed residence, and, except as otherwise provided or allowed, agrees to occupy the financed residence as his or her principal residence in accordance with the terms of the Co-Ownership Agreement. The Co-Ownership Agreement may include a provision in which the consumer may have the right to lease the financed residence for a term of years without the consent of the co-owner. This term can be whatever term the parties agree to, but typically it may be a term of three years or less. The Co-Ownership Agreement may also include certain limited rights of the co-owner with respect to the financed residence, subject to the consumer's right to occupy such residence, including the right to re-enter, to inspect, to cure defects, and approve of significant improvements in the residence.

Under the financing arrangement of the present invention, the consumer will typically not have the right to sell any portion of the co-owner's interest in the financed residence without the co-owner's consent. Preferably, however, under the Co-Ownership Agreement, the consumer has the right at any time to purchase the co-owner's interest in the financed residence by tendering an amount called the “buyout amount” or “buyout value”, which is essentially an amount that reflects the amount the co-owner has expended, and no more. Thus, upon a sale of the financed residence or refinancing by the consumer, the co-owner is entitled merely to the buyout value and does not participate in any gain due to an increase in market value of the property. The Co-Ownership Agreement can also provide that if the consumer sells the financed residence without first notifying the co-owner and tendering the buyout value, the consumer will be in default.

The Co-Ownership Agreement characterizes and allocates the monthly payments to be made by the consumer to the co-owner or its assignees. Each monthly payment is comprised of a profit payment, an acquisition payment, and other payments (for example, payments for escrow items), as specified in the Co-Ownership Agreement. The profit payment is the amount that the consumer pays the co-owner for the consumer's use of the property. The acquisition payment is the payment that is applied to increase the beneficial ownership of the consumer in the financed residence and to decrease the beneficial ownership of the co-owner. Preferably, the consumer may make pre-payments without a penalty.

The Co-Ownership Agreement will also typically provide for the consumer to be responsible for all real and personal property taxes, and general assessments levied and assessed against the property. Hazard insurance may be shared by the co-owner and consumer if agreed to in the Co-Ownership Agreement. If the consumer desires more comprehensive insurance, including comprehensive or “bundled” property, hazard and liability, the Co-Ownership Agreement will provide that the consumer pay and contract directly for such insurance. Per the Co-Ownership Agreement, the consumer will be responsible for utility expenses, any homeowner's association dues and other expenses associated directly with the cost of living in the home, including repairs and maintenance. Preferably, taxes and certain other items (such as insurance and the cost of maintaining the limited liability co-owner) are collected as escrow items as part of the monthly payment. The Co-Ownership Agreement can also provide for the right of the co-owner or its assignees to foreclose upon a default by the consumer. The Co-Ownership Agreement will also set forth the manner in which proceeds received from a casualty, condemnation or other event are allocated.

The consumer's Obligation to Pay provides for the consumer's obligation to make monthly payments to the co-owner and provide the terms for making such payments. The consumer's Obligation to Pay will also typically provide provisions addressing appropriate penalties, if any, for late payments and confirm that the consumer may make pre-payments without paying a penalty. Additionally, the consumer's Obligation to Pay provides for the co-owner's rights if the consumer defaults. Upon a default, the consumer's Obligation to Pay will provide that the co-owner has no recourse against the consumer's other assets, but may send the consumer written notice stating that the consumer may be obligated to pay the full buyout value to prevent foreclosure on the financed residence. Preferably, the consumer is given at least 30 days after the date of such a notice to pay the overdue amount. Preferably, if the consumer fails to pay the overdue amount within the specified period, the co-owner and its assignee may require the consumer to tender the buyout value, or enforce the co-owner's foreclosure rights. The consumer's Obligation to Pay also reflects the fact that the obligation is secured by a Security Instrument.

The Security Instrument sets forth in detail the payment obligations of the consumer, the obligations of the consumer with respect to the financed residence, and protection of the co-owner. It should be noted that many of the provisions in the Security Instrument are contained in the Co-Ownership Agreement and the consumer's Obligation to Pay. This is due to the need to protect the co-owner and its assignee together in a manner that creates a legally enforceable arrangement that maintains its integrity and does not violate Sharia. Preferably, the Security Instrument provides that the consumer is obligated to pay certain items, such as taxes, that can attain priority over the Security Instrument. Additionally, the Security Instrument can provide that the consumer will discharge promptly any lien which has priority over the Security Instrument, except in certain limited instances similar to a conventional mortgage.

Preferably, the Security Instrument provides for the protection of the co-owner's interest in the financed residence. If (a) the consumer fails to perform the covenants and agreements in the Security Instrument, (b) there is a legal preceding that might significantly affect the co-owner's interest in the financed residence and/or rights under the Security Instrument (e.g., a proceeding in bankruptcy), or (c) the consumer has abandoned the financed residence, the Security Instrument can provide that the co-owner may do and pay for whatever is reasonable or appropriate to protect the co-owner's interest in the financed residence and rights under the Security Instrument.

The Security Instrument also provides for the co-owner's protection in the event that the financed residence is damaged. The Security Instrument preferably provides that generally the co-owner is to receive any settlement or compensation proceeds up to the amount secured by the Security Instrument and the consumer is to receive the excess. The Security Instrument addresses the allocation of proceeds in a partial or total destruction of the property as well as in condemnation proceedings.

The Security Instrument also sets forth the co-owner's remedies upon a consumer default. These remedies include a Power of Sale and any other remedies permitted by applicable law. Generally, federal law and the law of the jurisdiction in which a financed residence is located govern the Security Instrument. States are generally divided into deed of trust and mortgage states. Because state laws differ on the remedies available upon default, the Security Instrument will typically contain state-specific language regarding the remedies available upon default. Generally, however, upon a consumer default, the co-owner sends a written Notice of Default to the consumer prior to exercising default remedies. The Notice of Default specifies the default, the action required to cure the default, the date by which the default must be cured, and a notice that a failure to cure the default on or before the date specified will result in the co-owner exercising remedies under the Security Instrument and sale of the financed residence. Typically, the date by which the default must be cured will be at least 30 days from the Notice.

State specific modifications may also be found in other agreements (i.e., commitment and Co-Ownership Agreement) where required by state and local law or otherwise to reconcile local law with the agreement between the parties, to protect the interests of the parties, and to allow the co-owner or its assignees to obtain first lien status on the financed property. The Security Instrument will also provide that if the co-owner invokes the power of sale, the co-owner is to provide written notice of commencement of foreclosure as required under applicable law and follow all other procedures under the applicable law. The Security Instrument will also provide for the consumer's right to re-instate after the default, provided certain conditions are met.

As stated above, the consumer at closing also signs an agreement allowing the co-owner to transfer certain rights and obligations to its assignee. The assignee is preferably the financier who will preferably transfer these rights on to an investor. The rights include most rights contained in the Co-Ownership Agreement, as well as rights under the consumer's Obligation to Pay and Security Instrument. The financier will enter into an assignment agreement (a second assignment used for carrying out the financing method of the present invention) with the secondary investor, such as Freddie Mac, assigning the interests held by the financier to the investor. From a Sharia law perspective, transferring the rights is tantamount to transferring ownership (i.e., Co-Ownership in the property). From a Sharia law perspective, debt can not be traded for other than its face value. By structuring the assignment in the Co-Ownership interest in a manner that passes through a deemed interest in the property and corresponding benefits and burdens, while keeping title and indemnity rights to third party claims in the limited liability co-owner, pricing efficiencies are created and the co-owner and financier and secondary investors and others are not prohibited from transferring or otherwise exchanging their interests in the financed property from a Sharia perspective. This has the benefit of creating a new asset class for Islamic investors.

### BRIEF DESCRIPTION OF THE DRAWINGS

FIG. 1 is a block diagram of a computer system for carrying out the financing method of the present invention.

FIGS. 2A-2D together are a flow chart for a system for originating a financing application and submitting the application to a secondary market investor for financing approval.

FIG. 3 is a flow chart of the pre-closing and closing steps in a home acquisition using the financing arrangement of the present invention.

FIG. 4 is a flow diagram of the pre-closing and closing steps in a mortgage replacement using the financing arrangement of the present invention.

FIG. 5 is a flow diagram of the post-closing steps for a home acquisition or a mortgage replacement using the financing arrangement of the present invention.

### DESCRIPTION OF THE PREFERRED EMBODIMENT

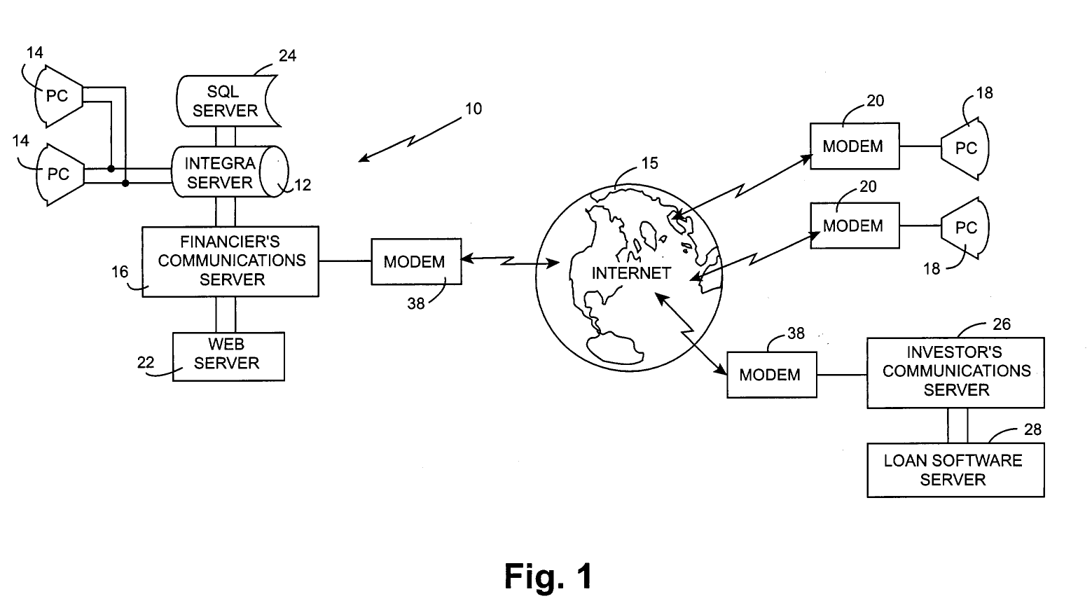

FIG. 1 is a block diagram illustrating a computer system 10 for carrying out the financing arrangement of the present invention. Shown in FIG. 1 is a server computer 12 that supports Destiny program origination software by Integra Software Systems (“Integra”), and that is directly connected to one or more desktop or laptop computers 14 used by financier's sales representatives to assist consumers in applying for home financing. The Integra server computer 12 is also connected to the Internet 15 through a communications server computer 16 so that one or more personal computers 18 can access a web page (not shown) that allows consumers to apply “on line” for home financing. Personal computers (“PCs”) 18 can be other types of devices used by consumers to access Internet 15, for example, a television with Internet access, but which is preferably a personal computer with a modem 20 for connecting to Internet 15.

A web server computer 22 includes a web server program (not shown), preferably Mortgagebot by Mortgagebot LLC, for presenting the web page used by consumers to apply for home financing. Web server 22 generates the screen displays used to obtain from consumers the information required for the consumers to apply for home financing. To this end, each consumer PC 18 typically includes in its memory (not shown) a web browser program for requesting the displays and relevant information from web server 22. Thus, each PC 18 is typically operated by a consumer desiring to browse the home financing web page, and perhaps apply for home financing.

Computer system 10 also includes an SQL server 24 which stores all application data from consumers applying for home financing. Integra server 12 performs standard calculations made with the Integra loan operating software. Communications server 16 is used to import into the Integra software credit reports and loan or “contract” underwriting decisions made by secondary market investors in response to consumer applications for financing.

Stored in the memory (not shown) of server 12 are a plurality of files (not shown) relating to the declining balance Co-Ownership financing method of the present invention. The files stored in server 12 include a file in which are stored the documents used with the declining balance Co-Ownership financing arrangement of the present invention. These documents for acquisition and replacement transactions include a Definition of Key Terms, a Co-Ownership Agreement, a consumer's Obligation to Pay, a Security Instrument, an Assignment Agreement and Amendment to Security Instrument, and a secondary assignment. State specific modifications of the documents are stored as well (all not shown). The files include documents to comply with the requirements of Truth-in-Lending and RESPA disclosures generated in connection with the creation and settlement of a contract for home financing. Required State disclosures are also stored on server 12. Preferably, state and federal disclosures are adapted to reconcile with the terminology and substance of the declining balance Co-Ownership documents. Data obtained from consumers in connection with their applications for home financing are entered in Integra server 12 and stored in SQL server 24. The information provided by consumers in connection with the financing application process is entered either through a computer 14 used by a sales representative working with a consumer to prepare a home financing application or directly by a consumer using a PC 18 connected to Integra server 12 through the Internet 15, web server 22 and communications server 16.

Although not specifically shown in FIG. 1, PCs 14 and 18, servers 12, 16, 22 and 24, and a communications server 26 and a loan software server 28 used by a secondary market investor to make contract/loan underwriting decisions would typically include central processing units (“CPUs”) and system buses that would couple various computer components to the CPUs. These system buses may be any of several types of bus structures, including a memory bus or memory controller, a peripheral bus, and a local bus using any of a variety of bus architectures. The memory used by these PCs and servers would also typically include random access memory (“RAM”) and one or more hard disk drives that read from, and write to, (typically fixed) magnetic hard disks. A basic input/output system (“BIOS”), containing the basic routines that help to transfer information between elements within a computer system, such as during start-up, may also be stored in read-only memory (“ROM”) of the PCs and servers. The PC and servers might also include other types of drives for accessing other computer readable media, such as removable “floppy” disks, or an optical disk, such as a CD ROM, or a CD-ReWritable disk. The hard disk, floppy disk, and optical disk drives are typically connected to a system bus by a hard disk drive interface, a floppy disk drive interface, and an optical drive interface, respectively. The drives and their associated computer-readable media provide non-volatile storage of computer-readable instructions, data structures, program modules, and other data used by the PCs and servers. Communications servers 16 and 26 will also include a communications device, such as a high speed modem 38, for connecting to Internet 15. Such communications devices 38 may be internal or external, and are typically connected through the computer's system bus via a serial port interface. The PCs and servers may also include other typical peripheral devices, such as printers, displays and keyboards. Typically, PCs 18 would include a display monitor (not shown) on which various web pages relating to the financing application process are displayed. Conversely, PCs 14 would include a display monitor on which various screens relating to the application process for collecting application data from consumers would be displayed.

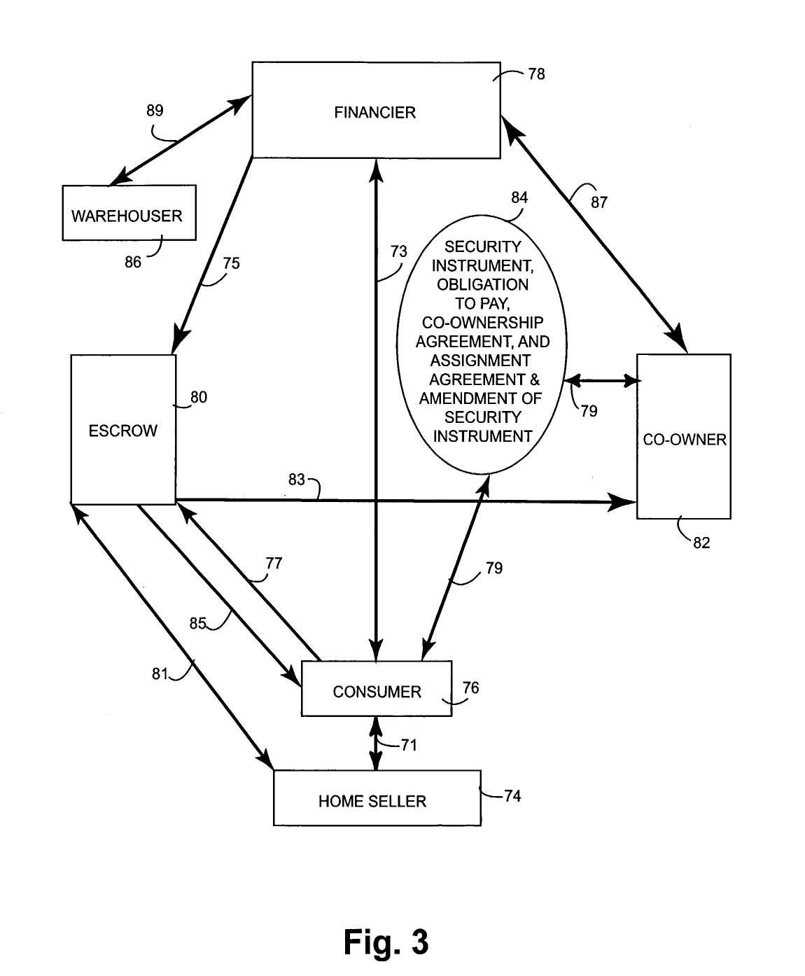

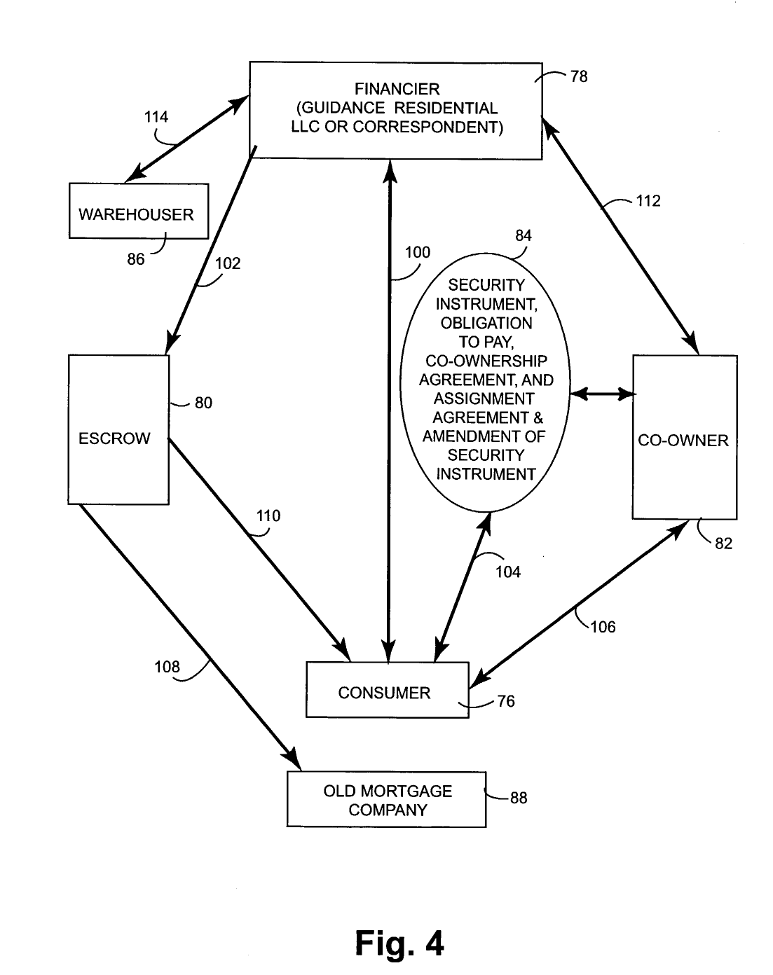

The declining balance co-ownership financing arrangement of the present invention can be used for two main purposes, i.e., for a consumer to finance the purchase of a home and for a consumer who already owns a home to refinance an existing financing arrangement, such as a traditional mortgage. FIG. 3 is a flow diagram of the process of a consumer 76 purchasing a home from a seller 74. FIG. 4 is a flow diagram of the process of a consumer 76, who already owns a home but seeks to replace an existing financing arrangement with another financing company, such as a mortgage company 88.

For the home purchase shown in FIG. 3, as with any home purchase, consumer 76 selects a property to purchase (not shown) at step 71 and enters into a standard residential contract of sale (not shown) with home seller 74. The residential contract of sale between consumer 76 and home seller 74 does not convey ownership, but, rather, is an agreement that provides consumer 76 with a right to acquire the property. After selecting a property to purchase and entering into the contract of sale at step 71, consumer 76 will typically then seek financing to assist consumer 76 with the purchase of the property. At step 73, consumer 76 seeks financing information from financier 78.

Alternatively, before selecting a property to purchase and making an offer on the property, consumer 76 can request a preliminary review from financier 78 that will enable financier 78, if consumer 76 qualifies, to pre-approve consumer 76 for financing up to a certain contract amount. Once consumer 76 is pre-approved by financier 78, financier 78 can provide consumer 76 with a pre-approval letter (not shown) that identifies consumer 76 as being qualified to purchase the property of a certain value. At this same time, financier 78 can educate consumer 76 about home acquisition using the declining balance Co-Ownership financing arrangement of the present invention. Preferably financier 78 will provide consumer 76 with an introduction package (not shown) that explains the terms of the arrangement. If seller 74 accepts consumer 76's purchase offer, consumer 76, again at step 73, completes a declining balance Co-Ownership application (not shown) with financier 78, and, based on this application, financier 78 makes a formal decision about the terms of the financing.

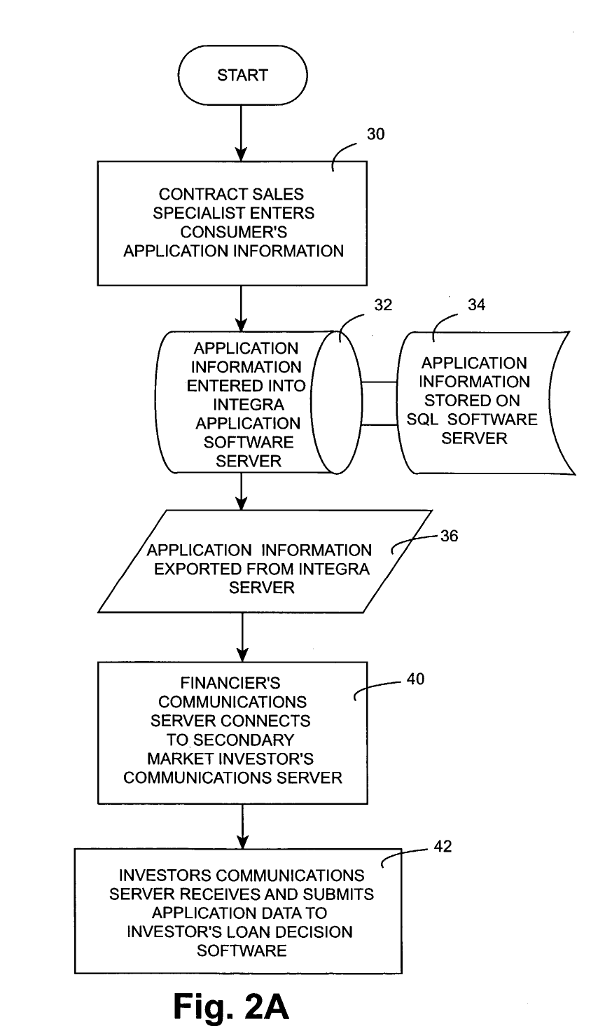

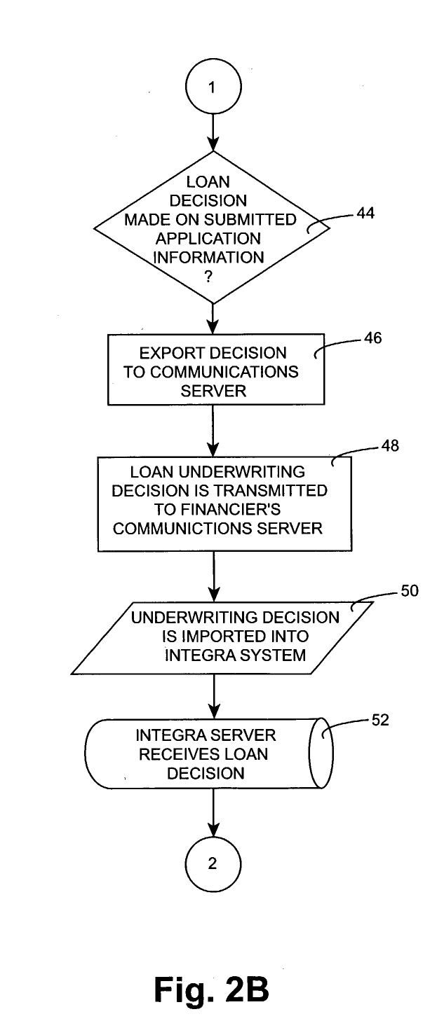

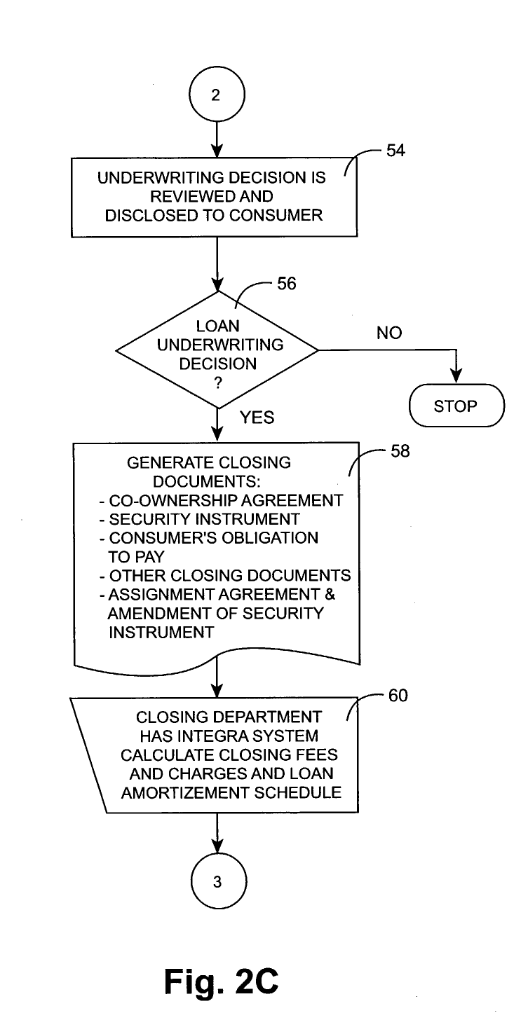

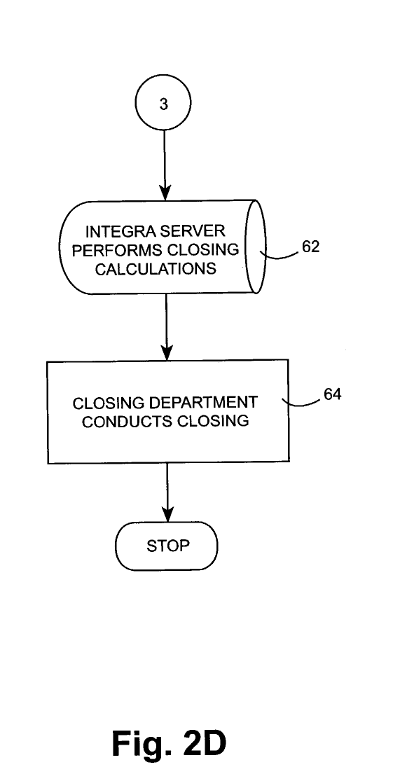

FIGS. 2A-2D are a flow chart for a loan/contract origination Integra system that is preferably used to process contract applications under the declining balance Co-Ownership financing arrangement of the present invention. To begin, at step 30, a contract sales specialist who works for financier 78, using one of PCs 14, enters certain information obtained from consumer 76 that is required for the contract financing application. The information is similar to that required for a conventional mortgage, including the amount sought for financing, information regarding the income of the applicant, as well as his or her assets and liabilities. The applicant's credit also plays a crucial role in the determination. The contract application information obtained from consumer 76 is entered into Integra server 12 at step 32. Ultimately, if the consumer's financing is approved, Integra 12 will calculate certain fees and charges associated with the contract, as well as a schedule for amortizing the financed amount to be paid back over a specified period of time. An example of a first payment made for a contract issued under the declining balance Co-Ownership financing arrangement of the present invention is shown in Table I below and discussed hereafter. Integra server 12 also prints any documents pertinent to the specified contract type, including all closing documents needed to complete a contract transaction.

The application information entered into Integra server 12 is then stored in SQL software server 24 at step 34. The SQL software server 24 shown in FIG. 1 holds all consumer data, which can be used for purposes other than the contract origination performed by the Integra software. One example is the integration of an accounting system with the SQL database. Integrating the two software systems eliminates double entry into the accounting system. The SQL database maintained by server 24 can also be used for reporting, mail-outs and follow-ups. The SQL software is a Microsoft product commonly used for database purposes.

Once the required application information is obtained from consumer 76 at step 30 by financier 78's contract sales specialists at step 36, the information is exported to a secondary market investor (such as Fannie Mae, Freddie Mac, or an investment banker) for an underwriting decision based on the application. At step 40, financier 78's communications server 16 (FIG. 1) connects through the Internet 15 to the secondary market investor's communications server 26. At step 42, the secondary market investor 92's communications server 26 receives the application data from financier 78's communications server 16 and submits it to its loan software server 28 for a loan decision on consumer 76's application. At step 44, loan software server 28 renders a loan/contract underwriting decision on the application information provided by financier 78 for consumer 76. One example of a program that performs the loan underwriting decision function is Freddie Mac's “Loan Prospector” program. Once an underwriting decision is made at step 44 (which is typically done in 5 to 10 minutes by loan software server 28), the decision is exported at step 46 to investor 78's communications server 26. Server 26 then transmits the decision back to financier 78, who receives the decision through its communications server 16 at step 48. The secondary market investor's underwriting decision is then imported, at step 50, back into the Integra system, and then the Integra server 12 at step 52. At step 54, the underwriting decision is received, printed out and reviewed by financier 78, and then disclosed to consumer 76.

If at step 56 financier 78 determines that consumer 76 was approved for financing, at step 58 consumer 76 is provided with a set of applicable agreements and disclosures. Consumer 76 and financier 78 will first enter into a Commitment Agreement (not shown) that describes the terms of the financing, including the required use of a co-owner and a Co-Ownership Agreement (not shown) for the purchase of the property. The Commitment Agreement commits financier 78 to consumer 76's property purchase transaction. Under the Commitment Agreement, financier 78 obligates itself to provide funds for use in the purchase transaction for the benefit of consumer 76 in exchange for consumer 76's promise that it will enter into the Co-Ownership Agreement with co-owner 82. This arrangement enables co-owner 82 to own all interests in the property to be purchased that are not owned by consumer 76. Along with the Commitment Agreement, financier 78 also sends consumer 76, at step 73, a Definition of Key Terms document (not shown) and an addendum (not shown) to the sales contract 71 putting home seller 74 on notice that a co-owner 82 will be involved in the purchase.

Assuming, by way of example, that consumer 76 makes a 20% initial acquisition payment for the purchase of a property, co-owner 82 would then have an 80% ownership interest in the property. Of course, consumer 76 can make an initial acquisition payment in any amount for which he qualifies, typically as low as 5%. Pursuant to the Commitment Agreement, at step 75 in FIG. 3, financier 78 then deposits 80% of the purchase price of the property into an escrow fund 80 for the benefit of consumer 76 for use in the purchase transaction. An option would be for consumer 76, at step 77, to also deposit the 20% initial acquisition payment into escrow fund 80.

During the pre-closing period, after financier 78 has executed the Commitment Agreement, consumer 76 resumes the role of a traditional purchaser in a traditional home acquisition transaction. Prior to closing, co-owner 82 plays no active role in the purchase transaction, relies upon consumer 76 to fulfill the traditional purchaser responsibilities, such as scheduling closing and depositing any necessary earnest money, etc. Similarly, consumer 76 will schedule typical home appraisal and home acquisition inspections, such as home, termite and structural inspections. In this regard, the terms of the Co-Ownership Agreement preferably will provide for a property inspection performed by a qualified home inspection service so that any severe defects, such as major structural problems or life-threatening deficiencies, can be identified and remedied prior to closing. To this end, consumer 76 preferably acknowledges, upon signing the Co-Ownership Agreement at closing, that such improvements have been performed.

Typically, consumer 76 will also be responsible for obtaining bundled home owner's insurance and earthquake, hurricane and flood insurance, where required. As in a typical mortgage situation, consumer 76 will generally choose an appropriate policy from an insurer of consumer 76's choice provided, however, that guaranteed replacement cost coverage with code update protection is required because of the unique distribution formula used when insurance proceeds are applied in certain circumstances. If the consumer desires hazard insurance only, the financier 78 will purchase such insurance and share the cost of the insurance with the consumer and in this case the financier may choose to recoup its share of the insurance costs in the pricing of the transaction at step 60. Also, assistance in arranging the insurance policies can be provided by financier 78, if requested.

Applicable law will also determine whether consumer 76 will also be responsible, after closing, for paying a Co-Ownership maintenance fee as part of consumer 76's monthly payment. The Co-Ownership maintenance fee is used to cover costs associated with the legal maintenance of co-owner 82, such as fees paid to the state of domicile and a registered agent fee. The fee is typically paid into an annual escrow fund 81 and disbursed at the end of each year to cover annual corporation tax, registered agent fee and other nominal amounts 78.

Co-owner 82 is a limited liability entity, such as a corporation, but preferably a Limited Liability Company (“LLC”), under the financing arrangement of the present invention. Co-Owner 82 is formed before the generation of closing documents 58, preferably by submitting formation documents (not shown) to the State of Delaware via facsimile or registered mail (not shown). The entity forming co-owner is an affiliate of financier (not shown). This arrangement is preferred because co-owner 82 is an entity and serves to limit exposure to liabilities to all other parties. If available at a reasonable cost, the exposure to liabilities would be covered through the purchase of insurance. The LLC may be a co-owner of more than one property. The co-owner will be tax efficient in that it will be a flow-through or disregarded entity whose activities are limited outside its state of domicile.

At closing, and in connection with parameters established by the Commitment Agreement and the Co-Ownership Agreement, consumer 76 comes to closing or settlement with an initial acquisition payment of 20% of the property purchase price, according to the above example. Consumer 76 will bring the initial acquisition payment if he has not already deposited the payment amount in escrow fund 80. Of course, as noted above, the initial acquisition payment can be a different percentage of the property purchase price. Under the same parameters established by the Commitment and Co-Ownership Agreements, the remaining 80% of the property purchase price has been deposited into escrow fund 80 by financier 78, or otherwise is made available prior to closing. This provision of funds by financier 78 prior to closing for the benefit of consumer 76 is based on the credit rating of consumer 76 and the obligations contained in the four agreements 84 signed, at step 79 of FIG. 3, by consumer 76 at closing: (1) the Co-Ownership Agreement, (2) the consumer's Obligation to Pay, (3) the Security Instrument, and (4) the Assignment Agreement and Amendment of Security Instrument. At step 79 of FIG. 3, co-owner 82 also executes the Co-Ownership Agreement, the Security Instrument, and the Assignment Agreement and Amendment of Security Instrument 84.

At closing, the purchase price for the property is released at step 81 of FIG. 3 from escrow account 80 to home seller 74, and ownership and title to the property is transferred from seller 74 to escrow. Simultaneously, at steps 83 and 85, ownership is transferred and title is held by consumer 76 and co-owner 82, typically as tenants-in-common in proportion to the percentages contributed by each to the purchase price of the property, in accordance with the declining balance Co-Ownership financing arrangement of the present invention. In most states, title to the purchased property will be held by consumer 76 and co-owner 82 as tenants-in-common. The recorded deed does not reflect specific ownership percentages of co-owner 82 and consumer 76, but will instead reference the Co-Ownership Agreement, which provides specific ownership percentages through an attached schedule. An example of such a schedule is shown in Table I below. Table I reflects the monthly payment made by consumer 76, the profit in each monthly payment realized by co-owner 82, the acquisition payment in each monthly payment used to increase consumer's ownership interest in the purchased property, the percentage increase in consumer 76's ownership of the property, the resulting percentage ownership by consumer 76 in the property as a consequence of the monthly payment, and the resulting percentage ownership by co-owner 82 in the property, also as a consequence of the monthly payment.

OWNERSHIP SCHEDULE

| | | | Increase in | Resulting | Resulting |
|---|---|---|---|---|---|
| Monthly | | Acquisition | Consumer | Consumer | Co-Owner |
| Payment | Profit | Payment | Ownership | Ownership | Ownership |
| $2,000 | $1,970 | $30 | 0.05% | 20.05% | 79.95% |
| $2,000 | $1,969 | $31 | 0.06% | 21.01% | 79.89% |

As can be seen in Table I, the first monthly payment of $2,000 will include a profit payment of $1,970 and an acquisition payment of $30. This payment results in a 0.05% increase in the consumer's ownership portion of the property. The resulting consumer ownership will be 20.05%, while the resulting co-owner's ownership will be 79.95%. These changes are based on the previous example where the consumer's down payment was 20% of the purchase price, with the remaining 80% financed by the co-owner. Similarly, the second monthly payment of $2,000 shown in Table I will include a profit payment of $1,969 and an acquisition payment of $31. This payment results in a 0.06% increase in the consumer's ownership, resulting in the consumer's ownership being 21.01% and the co-owner's ownership being 79.89%.

As noted above, the documents to be executed at closing by consumer 76 and co-owner 82 are the Co-Ownership Agreement, the Security Instrument, the consumer's Obligation to Pay, and the Assignment Agreement and Amendment to Security Instrument. The co-owner 82 does not sign the consumer's Obligation to Pay. At step 87 of FIG. 3, and simultaneous to other events at closing, co-owner 82 assigns its interests in the Co-Ownership Agreement, the consumer's Obligation to Pay, and the Security Instrument to financier 78, through the Assignment Agreement and Amendment of Security Instrument. At step 89, financier 78 then delivers the consumer's Obligation to Pay, the Co-Ownership Agreement, and a copy of the Security Instrument along with any other documentation requested to a warehouser 86. Upon delivery, financier 78 receives funds back from warehouser 86. In the event a warehouser is not involved, the documents (Co-Ownership Agreement and consumer's Obligation to Pay) will be delivered directly to the investor pursuant to a secondary assignment (not shown) or an intermediate investor such as one who provides mortgage insurance.

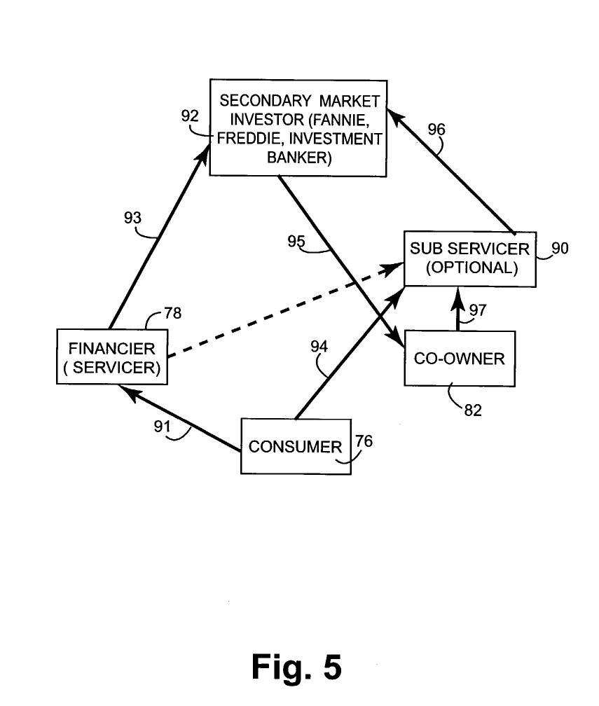

The Security Instrument creates a lien against the financed property and pledges the property as collateral for the declining balance contract provided by financier 78. After the Security Instrument is assigned to financier 78, it is ultimately assigned to a secondary market investor 92 (FIG. 5), such as Fannie Mae, Freddie Mac, or an investment banker. This allows investor 92 to foreclose against both co-owner 82 and consumer 76, if there is a default on the contract and neither party cures the default, thereby allowing investor 92 to obtain full fee simple ownership of the entire property, a typical remedy available under a traditional mortgage financing arrangement. The Security Instrument sets forth in detail the payment obligations of consumer 76, the obligations of consumer 76 with respect to the financed property, and the protection of co-owner 82. Many of the provisions in the Security Instrument are also contained in the Co-Ownership Agreement and the Consumer's Obligation to Pay. Under the Security Instrument, consumer 76 is obligated to pay certain items that can attain priority over the Security Instrument and is obligated to discharge promptly any lien which has priority over the Security Instrument, except in certain limited circumstances similar to that found in conventional mortgages.

The Security Instrument also provides for the protection of co-owner 82's interest in the financed property. If consumer 76 fails to perform the covenants and agreements in the Security Instrument, if there is a legal proceeding that might significantly affect co-owner 82's interest in the financed property, or if consumer 76 has abandoned the financed property, co-owner 82 may do and pay whatever is reasonable or appropriate to protect co-owner's interest in the financed property and rights under the Security Instrument.

The Security Instrument also provides for the co-owner's protection in the event the financed residence is damaged. Under the agreement, the co-owner preferably receives proceeds from the sale of the property up to the amount secured by the Security Instrument, after which any excess is paid to consumer 76. Where there is a total destruction or total condemnation, the Security Instrument provides for an allocation that serves to protect the co-owner's interest at the time of the loss or taking.

Under the Security Instrument, co-owner 82's remedies upon a default by consumer 76 include a power of sale and any other remedies permitted by applicable law. Generally, federal law and the law of the jurisdiction in which the financed property is located govern the Security Instrument. Because State laws may differ on the remedies of default, the Security Instrument will contain State-specific language regarding the remedies available upon default. In general, on a default by consumer 76, the Security Instrument specifies that co-owner 82 will send a written notice of default to consumer 76 prior to exercising any default remedies. Preferably, the notice of default specifies the default, the action required to cure the default, a specified period of days from the notice by which default must be cured, and a warning that a failure to cure the default on or before the date specified will result in co-owner 82 exercising remedies under the Security Instrument and sale of the financed property. Typically, the period specified for curing the default will be at least 30 days from the notice. The Security Instrument also specifies that if co-owner 82 invokes the power of sale, written notice of commencement of foreclosure will be provided to consumer 76, as required under applicable law. The Security Instrument also provides for consumer 76's right to reinstate after default, provided specified conditions are met.

By the consumer's Obligation to Pay, consumer 76 obligates himself to pay back the amount financed or acquisition amount to co-owner 82. Assignment by co-owner 82 to financier 78 of the consumer's Obligation to Pay fulfills co-owner 82's obligation to financier 78 for the financing provided by financier 78, and removes any obligation co-owner 82 has for payment. It also subjects co-owner 82's interest to a lien by financier 78. Any failure by consumer 76 to make payments under the terms of the consumer's Obligation to Pay constitutes a default. Co-owner 82 can then advance funds or buy out consumer 76, but if co-owner 82 elects to do neither, the right to foreclose on both parties' interests arises.

The Co-Ownership Agreement is executed by co-owner 82 to facilitate the acquisition of the purchased property by consumer 76 and to make a profit for itself. Co-owner 82 preferably retains legal and equitable title to the property throughout the life of the financing transaction. The key provisions of the Co-Ownership Agreement are as follows:

(i) Consumer 76 makes payments and acquires additional equity from co-owner 82. Each monthly payment has an acquisition payment that is a fractional amount applied in such a way as to increase consumer 76's ownership percentage. The actual increase in ownership will be held in abeyance and will be transferred formally at the time of a transfer event, such as a refinancing or sale of the property. This deferral of ownership may be necessitated by the imposition of transfer taxes in certain states in connection with each monthly transfer. In States that impose a transfer tax, the transfer may take place through alternative means, such as the sale of the co-owner to the consumer.

(ii) Consumer 76 can limit the profit payment at any time by buying out co-owner 82. If consumer 76 buys out co-owner 82, it is done at the previously established purchase price of the property.

(iii) The established acquisition price is the original home purchase price, less consumer 76's initial acquisition payment and subsequent acquisition payments.

(iv) Under a buyout, consumer 76 only pays profit participation payments due up to the date of the buyout.

(v) Consumer 76 can also make prepayments to the Amortization Schedule. Typically, a prepayment penalty is not charged, but could be if agreed to in the Co-Ownership Agreement, and is charged in accordance with applicable law. By prepaying, consumer 76 increases his ownership percentage and reduces co-owner 82's ownership percentage. Because of State law concerns, recognition of increased ownership by consumer 76 resulting from pre-payment may be held in abeyance in a deferred ownership account and transferred formally at the time of a transfer event.

(vi) Consumer 76 has the sole right to occupy the property, and, as consideration for such right, consumer 76 has the sole obligation to make payments for taxes, maintenance and generally insurance where not otherwise agreed.

(vii) The provisions of the Security Instrument specifying the remedies available to co-owner 82 (and its successors) are incorporated by reference into the Co-Ownership Agreement.

(viii) Co-owner 82 may retain the right to collect on behalf of the investor a standard late fee permitted by applicable law if consumer 76 does not make the monthly payment in a timely manner. If, pursuant to the consumer's Obligation to Pay, co-owner 82 charges such a fee, the amount in excess of the administrative costs and expenses may be given to a charitable entity of financier 78's choice, as approved by its Board of Director's, and if agreed to in the Co-Ownership Agreement. Preferably, the administrative costs and expenses are determined periodically and reviewed and approved by the financier's Sharia Board.

(ix) Co-owner 82 also has the right to collect other incidental costs (e.g., insufficient funds), but only an amount equal to its actual costs and expenses, or as otherwise agreed in the Co-Ownership Agreement.

(x) Co-owner 82 is obligated to deliver a quitclaim deed or its equivalent, or otherwise to make consumer 76 the 100% owner of the property when, through an early buy out or through making payments over the term evidenced by the schedule, consumer 76 purchases the last piece of co-owner 82's ownership in the property.

(xi) Immediately prior to the completion of the sale of the property, co-owner 82 assigns all of its interests to consumer 76. Thus, if there is a sale of the property, through means other than a foreclosure, any gains or losses are attributed to consumer 76 only. In the event of a foreclosure, consumer 76 and co-owner 82 are obligated only on a non-recourse basis, and therefore each loses its respective interest in the property. For remedies short of foreclosure, co-owner 82's equity is generally wiped out first. After the financier is satisfied, if any equity remains, consumer 76 is the beneficiary.

(xii) The rights and duties that are retained by co-owner 82 and its assignees under the Co-Ownership Agreement include:

1. the right to approve any additional financing on the property;

2. the right to approve any significant improvements to the property over a certain agreed upon amount, which is typically $5,000;

3. the right to approve certain lease agreements connected to the property (consumer 76 still has the obligation for payments);

4. the right, upon proper notice, to inspect the property;

5. the right to cure any defects regarding the property; and

6. the right to buy out consumer 76 (at fair market value based on third party appraisal) if consumer 76 fails to make proper payments.

Subsequent to closing, co-owner 82 delivers the consumer's Obligation to Pay, the Co-Ownership Agreement, and the Security Instrument, and the Assignment Agreement and Amendment to Security Instrument to financier 78 who delivers the required documentation to either warehouser 86 or directly to secondary market investor 92. Financier 78 then receives funds back for the delivery of the consumer's Obligation to Pay, the Co-Ownership Agreement and the Security Instrument.

Servicing of the contract will initially be performed by financier 78. Thus, initially consumer 76 sends his monthly payments to financier 78. Servicing may be sold or outsourced to a sub-servicer 90. Then, the monthly payment would be sent to sub-servicer 90. Whether a servicer or sub-servicer 90 is used, the monthly payments, net of a servicing fee, are passed onto secondary market investor 92.

Co-owner 76 initially carries out the responsibilities of ownership, as specified in the Co-Ownership Agreement, on behalf of secondary market investor 92. If consumer 76 fails to carry out his/her responsibilities under the several contracts, the co-owner will also be deemed to be in default.

The declining balance Co-Ownership financing arrangement of the present invention can also be used by a consumer who is seeking to replace an existing mortgage. Referring now to FIG. 4, at step 100, consumer 76 would apply for financing from financier 78 by completing a declining balance Co-Ownership application. As with the home acquisition situation discussed above, financier 78 would again make a formal decision about the terms of the financing that would involve the steps depicted in FIGS. 2A to 2D, such as obtaining the necessary contract application information from consumer 76 and submitting such information to secondary market investor 92 for an indication as to an underwriting decision. In the mortgage replacement situation, it is again contemplated that all disclosures under a traditional mortgage refinancing arrangement will be given to consumers who use the declining balance Co-Ownership financing arrangement. Thus, within three days of application, consumer 76 is provided with a set of applicable disclosures, including Truth-in-Lending and RESPA disclosures. Consumer 76 and financier 78 again enter into a commitment agreement that describes the terms of the financing, including the required use of co-owner 82, and a Co-Ownership Agreement, and a Commitment Agreement that commits financier 78 to the purchase transaction. Here again, under the Commitment Agreement, financier 78 obligates itself to provide funds for use in the transaction for the benefit of consumer 76 in exchange for consumer 76's promise that it will enter into the Co-Ownership Agreement with co-owner 82. This enables co-owner 82 to own all interests in the property not owned by consumer 76. Then, at step 102, financier 78 deposits the mortgage replacement amount into escrow fund 80.

When the commitment is executed, consumer 76 again resumes the role of a traditional consumer in a traditional mortgage refinancing situation. Prior to closing, co-owner 82 plays no active role in the refinancing transaction, and relies upon consumer 76 to fulfill traditional consumer responsibilities, such as scheduling closing, etc. Here, it is again contemplated that a mortgage replacement will require an appraisal acceptable to financier 78, which shall be accomplished through financier 78 with consumer 76's cooperation. The appraisal determines the maximum amount that can be financed for mortgage replacement purposes.

Typically, consumer 76 will generally also be responsible for obtaining bundled home owner's insurance and earthquake, hurricane and flood insurance, where required, provided, however, that guaranteed replacement cost coverage with code update protection is required because of the unique distribution formula used when insurance proceeds are applied in certain circumstances. As in a typical mortgage situation, consumer 76 will generally choose an appropriate policy from an insurer of the consumer's 76's choice. If the consumer desires hazard insurance only, the financier will purchase such insurance and share the cost of the insurance with the consumer, and, in this case, financier 78 may choose to recoup its increased costs in the pricing of the transaction. Also, assistance in arranging the insurance policies can be provided by financier 78, if requested.

Applicable law will also determine whether consumer 76 will also be responsible at closing for the cost of establishing co-owner 82, and after closing, for paying a Co-Ownership maintenance fee as part of the consumer's 76's monthly payment. The Co-Ownership maintenance fee is used to cover costs associated with the legal maintenance of an LLC, for example. The fee is typically paid into escrow fund 80 and disbursed at the end of each year to cover corporation tax, registered agent fee and other nominal amounts. Here again, the co-owner is formed in the same manner and purpose as in the acquisition transaction.

At closing, and in connection with parameters again established by the Commitment Agreement and the Co-Ownership Agreement, the mortgage replacement amount is deposited into escrow account 80 by financier 78 for the benefit of consumer 76 for use in the refinancing transaction. Here again, the provision of funds by financier 78 prior to closing for the benefit of consumer 76 is based upon the appraisal and the credit of consumer 76 and the obligations contained in the Co-Ownership Agreement, the Obligation to Pay, the Security Instrument and the Assignment Agreement and Amendment of Security Instrument that are executed by consumer 76 and co-owner 82 at closing. No fees, charges or profit is charged on the escrowed funds until such funds are disbursed at closing.

In the mortgage replacement situation, it is again contemplated that all closing costs are the responsibility of consumer 76. Included in the closing costs may be a Co-Ownership arrangement fee, which, for disclosure purposes, may be disclosed as an arrangement fee, or where required by law, as an origination fee and/or points. It is also contemplated that taxes, LLC establishment fee and insurance, which are also the responsibility of consumer 76, are escrowed.

At step 104 of FIG. 4, the Co-Ownership Agreement, the Security Instrument and the Assignment Agreement and Amendment of Security Instrument are executed at the closing by consumer 76 and co-owner 82. The Consumer's Obligation to Pay is executed at the closing only by consumer 76. Co-owner 82 enters into the Co-Ownership Agreement to facilitate the mortgage replacement by consumer 76 and to make a profit for itself. Co-owner 76 preferably retains legal and equitable title to the refinanced property throughout the life of the mortgage replacement transaction. The key provisions of the agreement in this regard are again like those in the home purchase situation discussed above. However, with regard to replacement transactions, co-owner 82 preferably does not hold legal or equitable title (although holding such title is preferable) due to transfer tax considerations in the jurisdiction where the property is located. Upon exit (extinguishment of co-owner's interest) there would be no need for a transfer of title where no interest in the title exists at the onset due to matters related to transfer tax. Where applicable, simultaneously, at step 106, and in connection with parameters established by the Commitment Agreement and the Co-Ownership Agreement, consumer 76 transfers the mortgage replacement co-owner's ownership to co-owner 82 through a deed which, where produced, may be recorded or unrecorded, depending upon the transfer tax regime in the particular jurisdiction. At the same time, at step 108, an amount equal to the outstanding mortgage amount that was held in escrow is transferred to the old mortgage company 88 for the benefit of consumer 76 for use in the refinancing transaction and the transaction is closed. Any amount in excess of the old mortgage amount that is invested by co-owner 82 is distributed to consumer 76 or applied, at consumer 76's discretion, from escrow account 80. To the extent that the mortgage replacement amount exceeds the outstanding mortgage amount, at step 110, the cash to consumer 76 will be transferred from escrow account 80 to closing for consumer 76's benefit. As part of the other events at closing, at step 112, co-owner 82 assigns its interests in the Co-Ownership Agreement and the Consumer's Obligation to Pay to financier 78, and, after subordinating its rights under the Security Instrument, transfers the Security Instrument to financier 78. This is accomplished through an Assignment Agreement and Amendment of Security Instrument signed by consumer 76 and co-owner at step 84. At step 114, financier 78 then delivers the consumer's Obligation to Pay, the Co-Ownership Agreement, and a copy of the Security Instrument and any other requested documents to warehouser 86 or directly or indirectly to the secondary market investor 92. Upon delivery, financier 78 receives funds back for the delivery of the agreements. In addition to replacing a conventional mortgage, consumer 76 may replace an existing contract under the declining balance Co-Ownership program, in which case, the procedure would be substantially identical to a transaction where a conventional mortgage is replaced under the declining balance Co-Ownership program.

The Co-Ownership Agreement, the consumer's Obligation to Pay, the Security Instrument and the Assignment Agreement and Amendment of Security Instrument, are all executed at closing by consumer 76 and co-owner 82, except for the consumer's Obligation to Pay that is not signed by co-owner 82 at closing. Co-owner 82 enters into these agreements to facilitate the mortgage replacement by consumer 76 and to make a profit for itself. Co-owner 82 preferably retains legal and equitable title to the refinanced property throughout the life of the mortgage replacement transaction, but may not where onerous transfer taxes exist under local law.

As in the home acquisition situation, in the mortgage replacement situation, title to the refinanced property as between consumer 76 and co-owner 82 will preferably be held by consumer 76 and co-owner as tenants-in-common. Here again, the recorded deed does not reflect specific ownership percentages of co-owner 82 and consumer 76, but, instead, references the Co-Ownership Agreement which, again, provides specific ownership percentages through an attached schedule, such as that shown in Table I. Thus, for example, if consumer 76 has a $100,000.00 traditional mortgage on a property that appraises for $300,000.00, and consumer 76, through a mortgage replacement, has co-owner 82 invest $200,00.00, the result would be $100,000.00 to consumer 76 with consumer 76's ownership being 33.4% of the property and co-owner 82's ownership being 66.6% of the property. Of course, if the declining balance Co-Ownership financing arrangement used involves a variable rate, the schedule is recalculated periodically during the term of the financing arrangement. In either event, each year consumer 76 receives a statement showing its ownership percentage at the beginning and end of the year.

Although the present invention has been described in terms of a particular embodiment, it is not intended that the invention be limited to that embodiment. Modifications of the disclosed embodiment within the spirit of the invention will be apparent to those skilled in the art. The scope of the present invention is defined by the claims that follow.

What is claimed is:

1. A method for a consumer to finance a property without making interest payments, the method comprising the steps of:
providing the consumer with funds to finance the property;
creating joint rights of ownership in the property in the consumer and a limited liability co-owner;
having the consumer make at least one payment to repay the funds, whereby full title to the property is transferred to the consumer alone after full repayment of the funds as agreed between the consumer and the limited liability co-owner, the at least one payment including a profit payment to the co-owner and an acquisition payment that increases the consumer's ownership portion of the property and simultaneously decreases the co-owner's ownership portion of the property.

2. The method of financing a property recited in claim 1, wherein the co-owner jointly purchases the property with the consumer as tenants-in-common.

3. The method of financing a property recited in claim 1, wherein the consumer makes a plurality of payments to the co-owner to repay the funds, and wherein each of the payments includes the profit payment and the acquisition payment.

4. The method of financing a property recited in claim 3, wherein the plurality of payments are monthly payments.

5. The method of financing a property recited in claim 1, wherein the co-owner is a legal entity with pass-through tax attributes and limited liability protection.

6. The method of financing a property recited in claim 5, wherein the co-owner is a legal entity selected from the group consisting of a limited liability corporation, a limited liability company, and a limited partnership.

7. The method of financing a property recited in claim 5, wherein the limited liability co-owner is registered in a low-cost jurisdiction and has limited activities that do not rise to the level of “doing business” for state corporate law purposes.

8. The method of financing a property recited in claim 1 further comprising the step of the consumer and the co-owner entering into a first agreement that specifies that the property will be jointly owned by the consumer and co-owner and that the at least one payment made by the consumer to the co-owner will include the profit payment and the acquisition payment.

9. The method of financing a property recited in claim 8, wherein the property is real property and the joint rights in the property of the consumer and the co-owner are created by a deed reflecting joint title to the property in the consumer and the co-owner.

10. The method of financing a property recited in claim 8, wherein the property is real property and the joint rights in the property of the consumer and the co-owner are created by a contract reflecting joint title to the property in the consumer and the co-owner.

11. The method of financing a property recited in claim 9, wherein the first agreement sets forth a schedule reflecting the consumer's ownership portion of the property and the co-owner's ownership portion of the property based on the at least one payment.

12. The method of financing a property recited in claim 8 further comprising the step of the consumer and the co-owner entering into a second agreement that provides for the consumer's obligation to make the at least one payment and the terms for making such payment.

13. The method of financing a property recited in claim 12, wherein the second agreement further provides for penalties for late payments and pre-payments by the consumer without paying a penalty.

14. The method of financing a property recited in claim 12, wherein the second agreement further provides for the co-owner's right of foreclosure if the consumer defaults on making the at least one payment.

15. The method of financing a property recited in claim 12 further comprising the step of the consumer and the co-owner entering into a third agreement setting forth the consumer's payment obligations, the consumer's obligations with respect to maintenance of the financed property, the consumer's obligations with respect to obtaining insurance of the financed property, and protections afforded the co-owner upon default by the consumer.

16. The method of financing a property recited in claim 15 further comprising the step of the consumer and the co-owner entering into a fourth agreement that assigns a majority of the co-owner's rights in the property to a financier financing the property, including the co-owner's rights under the first, second and third agreements.

17. The method of financing a property recited in claim 1 further comprising the steps of maintaining a record of increases in the consumer's ownership portion of the property and decreases in the co-owner's ownership portion of the property in a deferred ownership account and transferring the increases in the consumer's ownership portion and decreases in the co-owner's ownership portion formally at the time of a transfer event, such as refinancing or sale of the property.

18. The method of financing a property recited in claim 1, wherein the financing is used by the consumer to purchase the property.

19. The method of financing a property recited in claim 1, wherein the financing is used by the consumer to replace an existing financing arrangement.

20. The method of financing a property recited in claim 19, wherein the existing financing arrangement is a conventional mortgage arrangement or a previous declining balance Co-Ownership arrangement.

21. The method of financing a property recited in claim 1, wherein the co-owner is affiliated with a financier providing the consumer with the financing, and wherein the monthly payments are serviced by the financier.

22. The method of financing a property recited in claim 1, wherein the co-owner's rights in the financing transaction are transferred to a secondary market investor.

23. The method of financing a property recited in claim 1, wherein the co-owner's rights in the financing transaction are transferred first from a first secondary market investor and then to a second secondary market investor.

24. The method of financing a property recited in claim 21 further comprising the step of substituting a sub-servicer for the financier.

25. The method of financing a property recited in claim 15, wherein the first, second, and third agreements are transferred to a warehouser.

26. A method of a first party financing a property comprising the steps of:
obtaining a funding amount to finance the property through a second party that is a limited liability entity;
creating joint property rights in the property in the first and second parties;
making a plurality of payments from the first party to the second party to repay the funding amount, each payment including a profit payment to the second party and an acquisition payment that increases the first party's ownership portion of the property and decreases the second party's ownership portion of the property by an amount specified in an amortization schedule, whereby full title to the property is transferred to the first party by the second party after full repayment of the funding amount.

27. The method of financing a property recited in claim 26, wherein the profit payments made by the first party are deductible by the first party for income tax purposes.

28. The method of financing a property recited in claim 26, wherein the property is jointly titled in the first party and the second party.

29. The method of financing a property recited in claim 26, wherein the property is jointly held by the first and second parties as tenants-in-common.

30. The method of financing a property recited in claim 26, wherein the joint property rights in the property are reflected in a contract signed by the first and second parties.

31. The method of financing a property recited in claim 26, wherein the second party is a legal entity selected from the group consisting of a limited liability corporation, a limited liability company, a limited liability partnership, and a limited partnership.

32. The method of financing a property recited in claim 26 further comprising the step of the first and second parties entering into a first agreement that specifies that the property will be held jointly by the first and second parties as tenants-in-common and that each of the payments made by the first party to the second party will include the profit payment and the acquisition payment.

33. The method of financing a property recited in claim 32 further comprising the step of the first and second parties entering into a second agreement that provides for the first party's obligation to make the plurality of payments and the terms for making such payments, and for the imposition of penalties for late payments, and the ability to make pre-payments by the first party without paying a penalty.

34. The method of financing a property recited in claim 33 further comprising the step of the first and second parties entering into a third agreement setting forth the first party's payment obligations with respect to maintaining and insuring the financed property, and protections afforded the second party upon default by the first party.

35. The method of financing a property recited in claim 26 further comprising the steps of deferring formal transfers reflecting increases in the first party's ownership portion of the property and decreases in the second party's ownership portion of the property until the property is refinanced or sold or paid in full.

36. The method of financing a property recited in claim 26, wherein the financing is used by the first party to purchase the property.

37. The method of financing a property recited in claim 26, wherein the financing is used by the first party to replace an existing financing arrangement.

38. The method of financing a property recited in claim 26, wherein rights in the financing arrangement are transferred to a secondary market investor.

39. The method of financing a property recited in claim 34, wherein the first, second, and third agreements are transferred to a warehouser.

40. The method of financing a property recited in claim 34 further comprising the step of the consumer and the co-owner entering into a fourth agreement that assigns under the first, second, and third agreements, except the co-owner's rights of ownership of the property, the co-owner's rights in the property to a financier that is financing the property for the consumer.

41. A system for financing a property comprising:
means for a first party to obtain funds to finance the property;
means for creating property rights in the property jointly in the first party and a second limited liability party;
means for making a plurality of payments by the first party to repay the funds, each payment including a profit payment and an acquisition payment that increases the first party's ownership portion of the property and decreases the second party's ownership portion of the property by an amount specified in an amortization schedule, whereby full title to the property is transferred to the first party by the second party upon full repayment of the funds by the first party.

42. The system for financing a property recited in claim 41, wherein the means for creating the joint property rights is an agreement between the first and a third party committing the third party to provide the funds to the first party in exchange for the first party committing to titling the property jointly with the second party.

43. The system for financing a property recited in claim 42 further comprising a deed titling the property in the first party and the second party as tenants-in-common, the second party being affiliated with the third party.

44. The system for financing a property recited in claim 42, wherein the plurality of payments are made from the first party to a third party providing the financing funds to the first party.

45. The system for financing a property recited in claim 41, wherein the property is held by the first and second parties as tenants-in-common.

46. The system for financing a property recited in claim 42, wherein the second party is a legal entity selected from the group consisting of a limited liability corporation, a limited liability company, a limited liability partnership and a limited partnership.

47. The system for financing a property recited in claim 41 further comprising a first agreement between the first and second parties that specifies that the property will be held jointly by the first and second parties as tenants-in-common and that each of the payments made by the first party will be made to the second party and will include the profit payment and the acquisition payment.

48. The system for financing a property recited in claim 47 further comprising a second agreement between the first and second parties that provides for the first party's obligation to make the plurality of payments and the terms for making such payments, and for the imposition of penalties for late payments, and the ability to make pre-payments by the first party without paying a penalty.

49. The system for financing a property recited in claim 48 further comprising a third agreement between the first and second parties setting forth the first party's payment obligations with respect to maintaining and insuring the financed property, and protections afforded the second party upon default by the first party.

50. The system for financing a property recited in claim 49 further comprising a fourth agreement between the first and second parties that assigns most of the second party's rights in the property to a third party that is providing the financing under the first, second, and third agreements.

51. The system for financing a property recited in claim 41 further comprising means for recording deferrals of formal transfers reflecting increases in the first party's ownership portion of the property and decreases in the second party's ownership portion of the property until the property is refinanced or sold.

52. The system for financing a property recited in claim 41, wherein the financing is used by the first party to purchase the property.

53. The system for financing a property recited in claim 41, wherein the financing is used by the first party to replace an existing financing arrangement.

54. A system for financing a property comprising:
a first computer for initiating an application by a consumer to obtain funds to finance the property;
a second computer for deciding whether to provide the consumer with the funds to finance the property, the first and second computers being in communication with one another;
a document for creating property rights jointly in the consumer and a limited liability co-owner as tenants-in-common;
a third computer for tracking a plurality of payments by the consumer to repay the funds, each payment including a profit payment to the co-owner and an acquisition payment that increases the consumer's ownership portion of the property and decreases the co-owner's ownership portion of the property, whereby full title to the property is transferred to the consumer by the co-owner upon full repayment of the funds; and
a Co-Ownership agreement between the consumer and co-owner requiring the property to be jointly held by the consumer and co-owner as tenants-in-common and each of the payments made by the consumer to the co-owner to include the profit payment and the acquisition payment.

55. The system for financing a property recited in claim 54 further comprising an obligation to pay agreement between the consumer and co-owner providing for the consumer's obligation to make the plurality of payments and the terms for making such payments, and for the imposition of penalties for late payments, and the ability to make pre-payments by the consumer without paying a penalty.

56. The system for financing a property recited in claim 55 further comprising a security agreement between the consumer and co-owner setting forth the consumer's payment obligations with respect to maintaining and insuring the property, and protections afforded the co-owner upon default by the consumer.

57. The system for financing property recited in claim 56 further comprising a first assignment for assigning the co-owner's rights in the property under the Co-Ownership, obligation to pay and security agreements, except for the co-owner's ownership of the property, to a financier that is providing the financing to the consumer.

58. The system for financing property recited in claim 57 further comprising a second assignment for assigning the co-owner's rights from the financier to an investor in the secondary market.

59. The system for financing a property recited in claim 54 further comprising a fourth computer operated by the consumer for sending through the Internet to the first computer an application to obtain funding to finance the property.

60. The system for financing a property recited in claim 59 wherein the first computer provides a web site through which the fourth computer operated by the consumer sends an application for funds to the first computer through the Internet.

61. The system for financing a property recited in claim 54 further comprising a fourth computer for recording the increases in the consumer's ownership portion of the property and the decreases in the co-owner's ownership portion of the property and for generating the documents necessary for transferring the ownership portions from the co-owner to the consumer when the property is refinanced or sold.

62. The system for financing a property recited in claim 54, wherein the financing is used by the consumer to purchase the property.

63. The system for financing a property recited in claim 54, wherein the financing is used by the consumer to replace an existing financing arrangement.

64. A method for a consumer to finance a property, the method comprising the steps of:
providing the consumer with funds to finance the property;
creating joint rights of ownership in the property in the consumer and a co-owner that is a legal entity with limited liability;
making a plurality of payments by the consumer to repay the funds, whereby full title to the property is transferred to the consumer alone after full repayment of the funds by the consumer, each payment by the consumer including a profit payment and an acquisition payment that increases the consumer's right of ownership interest in the property and simultaneously decreases the co-owner's right of ownership interest in the property; and
transferring the co-owner's rights in the financing by the consumer to an investor.

65. The method of financing a property recited in claim 64, whereby the payments by the consumer are made to the co-owner.

66. The method of financing a property recited in claim 64, whereby the payments by the consumer are made to a financier providing the funds to the consumer to finance the property.

67. The method of financing a property recited in claim 64, whereby the payments by the consumer are made to a servicer.

68. The method of financing a property recited in claim 64, whereby the investor is a secondary market investor.

69. The method of financing a property recited in claim 68, further comprising the step of transferring the co-owner's rights in the financing to a second investor that is a secondary market investor.

70. A method for a consumer to finance a property, the method comprising the steps of:
providing the consumer with funds to finance the property;
creating joint rights of ownership in the property in the consumer and a co-owner that is a legal entity with limited liability; and
making a plurality of payments by the consumer to repay the funds, whereby full title to the property is transferred to the consumer alone after full repayment of the funds by the consumer, each payment by the consumer including an acquisition payment that increases the consumer's right of ownership interest in the property and simultaneously decreases the co-owner's right of ownership interest in the property.

71. The method of financing a property recited in claim 70, whereby the payments by the consumer are made to or through the co-owner.

72. The method of financing a property recited in claim 70, whereby the payments by the consumer are made to a financier providing the funds to the consumer to finance the property.

73. The method of financing a property recited in claim 70, wherein the joint rights in the property of the consumer and the co-owner are created by a contract including a deferred ownership account evidencing a record of increases in the consumer's ownership portion of the property and decreases in the co-owner's ownership portion of the property and providing for a transfer of the increases in the consumer's ownership portion and decreases in the co-owner's portion formally at the time of a full purchase of the property by the consumer or a transfer event, such as a refinancing or sale of the property.

74. The method of financing a property recited in claim 70 further comprising the step of transferring the co-owner's rights in the financing by the consumer to an investor.
